(19) United States
(12) Patent Application Publication
(10) Pub. No.: US 2013/0054774 A1
(43) Pub. Date: Feb. 28, 2013

(54) MANAGEMENT SYSTEM, MANAGEMENT METHOD, AND STORAGE MEDIUM

(71) Applicant: Koji Kikuchi, Yokohama-shi (JP)

(72) Inventor: Koji Kikuchi, Yokohama-shi (JP)

(73) Assignee: CANON KABUSHIKI KAISHA, Tokyo (JP)

(21) Appl. No.: 13/571,238

(22) Filed: Aug. 9, 2012

(30) Foreign Application Priority Data
Aug. 23, 2011 (JP) 2011-181473

(51) Int. Cl. G06F 15/16

(52) U.S. Cl. 709/223

(57) ABSTRACT

A management server issues and stores a virtual identifier for an image forming apparatus, and manages a virtual device that includes management information about the image forming apparatus by associating the virtual device with the virtual identifier. The management server receives an acquisition request for a virtual device that includes the actual identifier for the image forming apparatus and a virtual identifier from the image forming apparatus. The management server specifies the virtual device corresponding to the virtual identifier included in the virtual device acquisition request from among the managed virtual devices. Further, the management server replaces the virtual identifier included in the specified virtual device with the actual identifier included in the virtual device acquisition request, and then returns this virtual device to the image forming apparatus.

### BACKGROUND OF THE INVENTION

1. Field of the Invention

The present invention relates to a management system, a management method, and a storage medium.

2. Description of the Related Art

An image forming apparatus that stores configuration data, which is a setting value for switching an operation of the image forming apparatus, has been proposed. Further, an image forming apparatus that additionally installs software to add a new function or to expand an existing function by applying that added software thereto has also been proposed.

The configuration data and added software are stored in a storage device that is included in the image forming apparatus. Therefore, in a printing system including a plurality of image forming apparatuses, the number of times that the configuration data and the added software has to be set in all of the image forming apparatuses is equal to the number of apparatuses.

To make the setting operation for a plurality of image forming apparatuses more efficient, Japanese Patent Application Laid-Open No. 2007-130838 discusses an image forming system in which the plurality of image forming apparatuses refer via a network to system initial setting information managed by a server.

The image forming system discussed in Japanese Patent Application Laid-Open No. 2007-130838 is a system in which the plurality of image forming apparatuses apply configuration data common to all of the image forming apparatuses by referring to a server. Therefore, in this image forming system, configuration data and added software that differ among image forming apparatus models cannot be uniformly managed for each image forming apparatuses.

However, a management system could be provided that uniformly manages management information (configuration data and added software) that differ among image forming apparatus models for each image forming apparatus by using an identifier given in advance to the image forming apparatus machine for identifying the image forming apparatuses. More specifically, a management server included in this management system manages the management information by associating an identifier with each image forming apparatus.

However, until the image forming apparatus has actually been installed at the environment where the user will use the apparatus (usage environment) and the machine has been determined, the identifier of the installed image forming apparatus may not be determined. For example, a case will be considered in which, using an identifier notified from the vender when the user purchased the image forming apparatus, a management server manages configuration data about the purchased image forming apparatus before the image forming apparatus is delivered to the user.

First, if the identifier notified to the user is mistaken due to an input mistake by the vendor, the management information will be managed using that mistaken identifier. Further, if an image forming apparatus having a different identifier to the identifier notified from the vendor is delivered from the user due to an image forming apparatus delivery mistake, the management information about this image forming apparatus will not be managed in the management server. Consequently, conventionally, it has been difficult for a management server to manage management information about an image forming apparatus before the image forming apparatus machine has been determined.

### SUMMARY OF THE INVENTION

The present invention features a management system and a management method capable of managing management information about an image forming apparatus before the image forming apparatus machine has been determined.

According to an aspect of the present invention, a management system comprising an image forming apparatus and a server apparatus configured to manage management information about the image forming apparatus that includes at least operation setting information for switching an operation in the image forming apparatus, wherein the server apparatus includes an issuing unit configured to issue provisional identification information about the image forming apparatus, a first storage unit configured to store the issued provisional identification information, a generation unit configured to generate correspondence information as apparatus information between the management information about the image forming apparatus and the provisional identification information, a second storage unit configured to store the generated apparatus information, a request receiving unit configured to receive an acquisition request for the apparatus information that includes the provisional identification information about the image forming apparatus and actual identification information about the image forming apparatus from the image forming apparatus via a network, an update unit configured to specify apparatus information corresponding to the provisional identification information included in the apparatus information acquisition request from among apparatus information stored in the second storage unit, and update the specified apparatus information by associating the specified apparatus information with the actual identification information included in the apparatus information acquisition request, and a sending unit configured to send the updated apparatus information to the image forming apparatus via the network.

According to another aspect of the present invention, management information about an image forming apparatus can be managed by a server apparatus even when the image forming apparatus machine to be applied at a user's environment is yet to be determined. Consequently, for example, the server apparatus can set in advance in the image forming apparatus configuration data and added software to be applied at the user's environment.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an overall configuration example according to an exemplary embodiment of the present invention.

FIG. 2 illustrates an example of a hardware configuration of a management system according to an exemplary embodiment of the present invention.

FIG. 3 illustrates an example of a function block diagram of a management system according to an exemplary embodiment of the present invention.

FIGS. 4A and 4B respectively illustrate an example of a virtual device generation screen and a virtual device advanced settings screen.

FIGS. 5A and 5B respectively illustrate an example of virtual identifier data and a virtual device.

FIGS. 6A and 6B respectively illustrate an example of virtual configuration data and virtual added software data.

FIG. 7 is a flowchart illustrating an example of virtual device acquisition processing.

FIG. 8 is a flowchart illustrating an example of management server operation processing.

FIG. 9 illustrates an example of virtual identifier data according to another exemplary embodiment.

### DESCRIPTION OF THE EMBODIMENTS

Various exemplary embodiments, features, and aspects of the invention will be described in detail below with reference to the drawings.

An information processing system according to an exemplary embodiment of the present invention will now be described. First, the terms used in the present exemplary embodiment will be defined. Configuration data is data that switches an image forming apparatus operation. Examples include an imposition default value during copying. Added software is software that is to be additionally installed (applied) in the image forming apparatus.

Installing added software in the image forming apparatus can add a new function to the image forming apparatus or expand an existing function. The installation of the added software in the image forming apparatus is subjected to license management using an image forming apparatus identifier. This prevents added software from being mistakenly installed in image forming apparatuses other than the image forming apparatus in which the added software is to be installed.

A virtual device is a data group about a real device that is stored in a management server. The virtual device functions as apparatus information corresponding to an image forming apparatus. The virtual device includes management information that contains at least configuration data about the image forming apparatus. The management server manages the virtual device and the real device (image forming apparatus) based on a one-to-one association.

In the present exemplary embodiment, the image forming apparatus acquires a virtual device corresponding to that image forming apparatus from the management server, and applies this virtual device to the image forming apparatus. For example, the user of the image forming apparatus can confirm the content of the virtual device to be applied to the image forming apparatus by using the image forming apparatus to display the virtual device before it is applied to the image forming apparatus.

To distinguish between the data included in the virtual device and the data stored in the real device, the following definitions will be used. Configuration data included in the virtual device will be referred to as “virtual configuration data”, and added software included in the virtual device will be referred to as “virtual added software”. Further, configuration data stored in the actual image forming apparatus will be referred to as “configuration data”, and added software stored in the actual image forming apparatus will be referred to as “added software”.

In addition, an image forming apparatus identifier virtually issued for the virtual device will be referred to as a “virtual identifier”. Specifically, a virtual identifier is a provisional identifier for the image forming apparatus. Moreover, an identifier stored in the actual image forming apparatus will be referred to as an “actual identifier”. Although the identifier value is, for example, a 10 digit number such as “1234567890”, the identifier format is not limited.

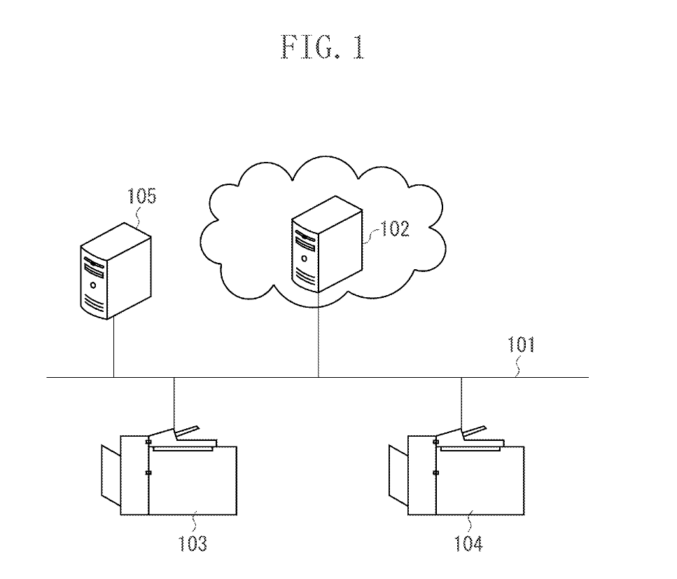

FIG. 1 illustrates an overall configuration example according to the present exemplary embodiment. The management system illustrated in FIG. 1 includes a management server 102, image forming apparatuses 103 and 104, and a client personal computer (PC) 105. A network 101 includes a local area network (LAN) and the Internet. The management server 102, the image forming apparatuses 103 and 104, and the client PC 105 can communicate with each other via the network 101.

The management server 102 is a server apparatus for managing a virtual device corresponding to an image forming apparatus. The virtual device includes at least operation setting information for switching an image forming apparatus operation. The management information may also include information relating to added software to be applied to an image forming apparatus.

The client PC 105 sets in the management server 102 a virtual device corresponding to the image forming apparatus 103 and a virtual device corresponding to the image forming apparatus 104. For this purpose, the client PC 105 sends a virtual device generation request and a virtual identifier issuance request to the management server 102 via the network 101. The virtual device generation request is a request for a virtual device to be generated.

The virtual device generation request includes management information about the image forming apparatus. The management information about the image forming apparatus is, for example, information relating to the virtual configuration data and the virtual added software.

The virtual identifier issuance request is a request for a virtual identifier to be issued. A virtual identifier is a provisional identifier for an image forming apparatus. For example, if a user has purchased an image forming apparatus from a vendor but the image forming apparatus is yet to arrive, the user operates the client PC 105 and requests the issuance of a virtual identifier.

The management server 102 issues a virtual identifier based on the virtual identifier issuance request sent from the client PC 105. Further, the management server 102 generates a virtual device by associating the management information about the image forming apparatus that includes the virtual device issuance request with the issued virtual identifier, and manages the generated virtual device.

Consequently, the management server 102 can manage the management information about the image forming apparatus using an virtual identifier for that image forming apparatus even when the image forming apparatus purchased by the user from a vendor has still not arrived.

The management server 102 also receives a virtual device acquisition request from the management server 102. The virtual device acquisition request is a request for a virtual device to be sent. The virtual device acquisition request includes an image forming apparatus identifier and an image forming apparatus virtual identifier.

The image forming apparatus identifier is an actual identifier given to the image forming apparatus machine. For example, when an image forming apparatus purchased by the user from a vendor arrives at the user's environment, an identifier has been given by the vendor to that image forming apparatus machine.

Further, the user operates the client PC 105 to output a virtual identifier for that image forming apparatus. In addition, the user operates the image forming apparatus to send a virtual device acquisition request including the identifier given to the image forming apparatus and the virtual identifier output by the client PC 105, to the management server 102.

The management server 102 specifies the virtual device corresponding to the virtual identifier included in the virtual device acquisition request from among the managed virtual devices. Then, the management server 102 replaces the virtual identifier included in the specified virtual device with the image forming apparatus identifier included in the virtual device acquisition request.

Consequently, the user can manage in the management server 102 management information about the relevant image forming apparatus using the determined actual identifier at the stage when the image forming apparatus purchased from the vendor has arrived at the user's environment and the identifier given to the image forming apparatus machine has been determined.

The image forming apparatuses 103 and 104 are processing apparatuses (e.g., a printer, a multifunction peripheral) that print and output image data. The image forming apparatus 103 sends a virtual device acquisition request to the management server 102 via the network 101. Further, the image forming apparatus 103 acquires a virtual device from the management server 102 based on the virtual device acquisition request.

In addition, the image forming apparatus 103 executes processing based on the management information included in the acquired virtual device. For example, the image forming apparatus 103 applies configuration data included in the management information to the image forming apparatus 103. Moreover, for example, the image forming apparatus 103 applies virtual added software included in the management information to the image forming apparatus 103. The image forming apparatus 104 has similar configuration to the image forming apparatus 103.

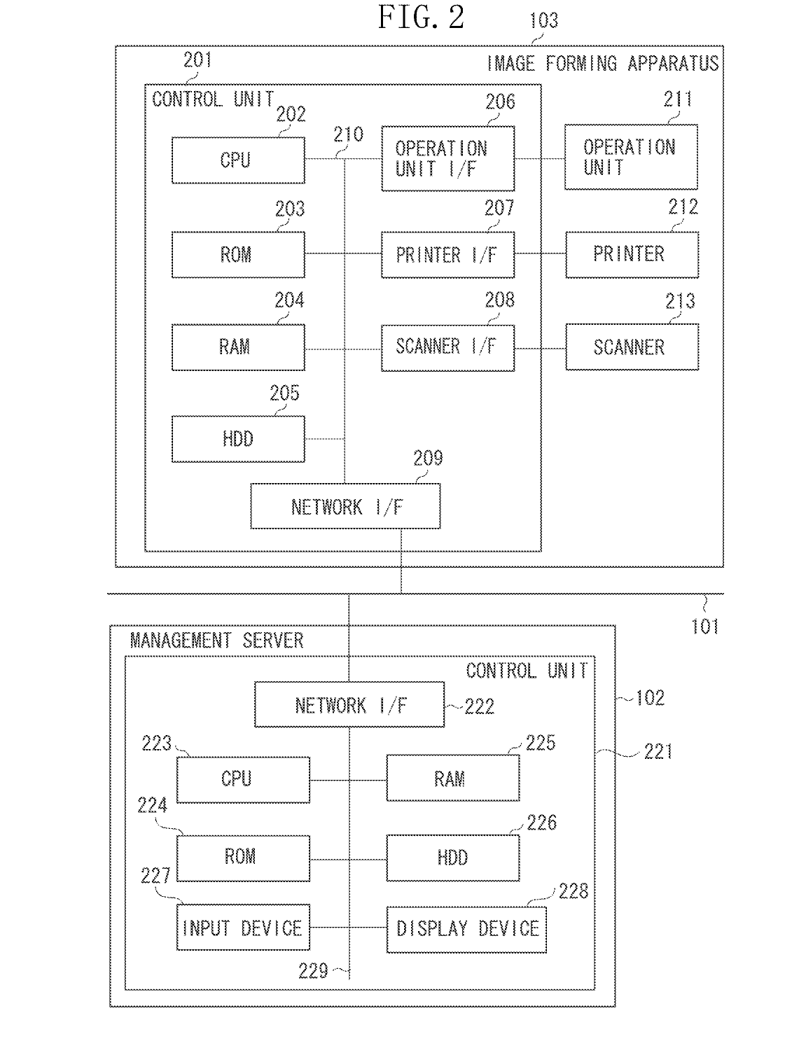

FIG. 2 illustrates an example of a hardware configuration of a management system according to the present exemplary embodiment. In FIG. 2, the hardware configuration of the image forming apparatus 103 and the management server 102 are illustrated. The hardware configuration of the client PC 105 is similar to the hardware configuration of the management server 102.

The image forming apparatus 103 includes a control unit 201, an operation unit 211, a printer 212, and a scanner 213. The control unit 201 performs overall control of the image forming apparatus 103. The operation unit 211 inputs information based on a user operation. For this purpose, the operation unit 211 includes a display unit (e.g., a liquid crystal display unit having a touch panel function etc.). The scanner 213 generates image data by reading an image on an original document. The scanner 213 transfers the image data to the control unit 201 via a scanner interface (I/F) 208.

The control unit 201 includes a central processing unit (CPU) 202, a read-only memory (ROM) 203, a random access memory (RAM) 204, and a hard disk drive (HDD) 205. Further, the control unit 201 also includes an operation unit I/F 206, a printer I/F 207, the scanner I/F 208, and a network I/F 209. The units from the CPU 202 to the network I/F 209 are connected to an internal bus 210.

The CPU 202 executes various control processes by reading control programs stored in the ROM 203. The RAM 204 is used as a main memory for the CPU 202 and a temporary storage area such as a work area. The HDD 205 stores image data, various programs, and various information tables.

The operation unit I/F 206 connects the operation unit 211 and the control unit 201. The printer I/F 207 connects the printer 212 and the control unit 201. Image data to be printed by the printer 212 is transferred to the printer 212 from the control unit 201 via the printer I/F 207, and printed on a recording medium by the printer 212. The scanner I/F 208 connects the scanner 213 and the control unit 201. The network I/F 209 sends and receives various information to and from the management server 102, for example, on the network 101.

When power of the image forming apparatus 103 is turned on, the CPU 202 initializes the apparatus based on a boot program in the ROM 203, loads an operating system (OS) in the HDD 205, for example, and then operates various applications.

The management server 102 includes a control unit 221 that controls the whole management server. The control unit 221 includes a network I/F 222, a CPU 223, a ROM 224, a RAM 225, an HDD 226, an input device 227, and a display device 228. The units from the network I/F 222 to the display device 228 are connected to an internal bus 229.

The CPU 223 executes various control processes by reading control programs stored in the ROM 224. The RAM 225 is used as a main memory for the CPU 223 and a temporary storage area such as a work area. The HDD 226 stores image data, various programs, and various information tables.

The input device 227 is a keyboard, a mouse, and the like that receives a selection instruction from the user, and transfers the selection instruction to the CPU 223 via the internal bus 229. The display device 228 notifies the user of information. The network I/F 222 connects the control unit 221 to the network 101, and sends and receives various information to/from the image forming apparatuses on the network 101.

When power of the management server 102 is turned on, the CPU 223 initializes the management server 102 based on a boot program in the ROM 224, loads an OS in the HDD 226, for example, and then operates various applications.

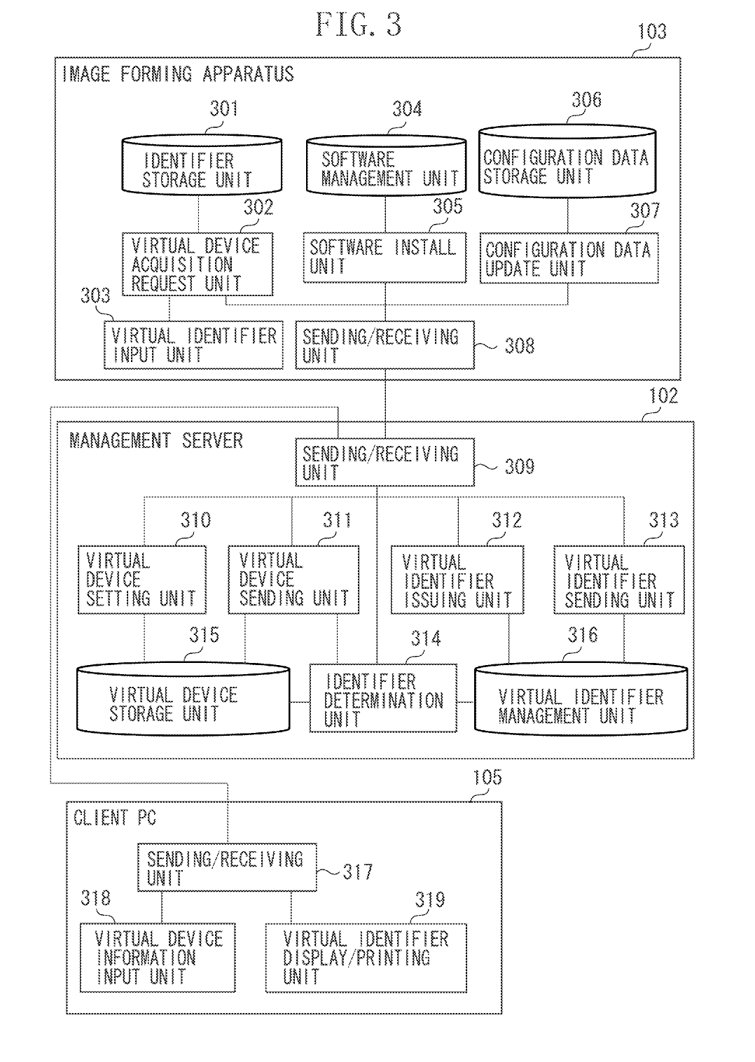

FIG. 3 illustrates an example of a function block diagram of the management system according to the present exemplary embodiment. The management method according to the present exemplary embodiment is realized by the functions of the management system illustrated in FIG. 3. Further, the computer program according to the present exemplary embodiment causes a computer to execute this management system.

The image forming apparatus 103 includes an identifier storage unit 301, a virtual device acquisition request unit 302, a virtual identifier input unit 303, a software management unit 304, a software install unit 305, a configuration data storage unit 306, a configuration data update unit 307, and a sending/receiving unit 308.

The functions of the above-described respective processing units included in the image forming apparatus 103 are realized by the CPU 202 executing a program stored in the ROM 203 or the HDD 205. Further, the CPU 202 executes the relevant program using various information stored in the RAM 204 or the HDD 205.

The identifier storage unit 301 stores identifiers, which are identification information that uniquely identify an image forming apparatus machine over the lifecycle of an image forming apparatus from shipping to disposal. For example, an identifier is given in advance by the vendor of the image forming apparatus, and stored in the identifier storage unit 301. The virtual device acquisition request unit 302 generates a virtual device acquisition request.

A virtual device acquisition request includes an identifier stored in the identifier storage unit 301 or both of the identifier and a virtual identifier. This virtual identifier is a virtual identifier input by the below-described virtual identifier input unit 303.

The virtual device acquisition request unit 302 sends the generated virtual device acquisition request to the management server 102 via the sending/receiving unit 308 and the network 101. Then, the virtual device acquisition request unit 302 acquires a virtual device from the management server 102.

The virtual identifier input unit 303 inputs the virtual identifier corresponding to the image forming apparatus 103. For example, the virtual identifier input unit 303 inputs the virtual identifier to the image forming apparatus 103 that was output by a virtual identifier display/printing unit 319 in the client PC 105.

The software install unit 305 acquires and installs the added software corresponding to the virtual added software ID included in the virtual device acquired by the virtual device acquisition request unit 302. The software management unit 304 manages the installed added software. The CPU 202 (FIG. 2) realizes the addition of functions in the image forming apparatus and function expansion by executing the added software that is managed by the software management unit 304.

The configuration data storage unit 306 stores the configuration data corresponding to the image forming apparatus 103. The configuration data update unit 307 updates the virtual configuration data corresponding to the virtual configuration data ID included in the virtual device acquired by the virtual device acquisition request unit 302 and the configuration data stored in the configuration data storage unit 306. The sending/receiving unit 308 performs all of the sending and receiving processing of information between the image forming apparatus 103 and the management server 102.

The management server 102 includes a sending/receiving unit 309, a virtual device setting unit 310, a virtual device sending unit 311, a virtual identifier issuing unit 312, a virtual identifier sending unit 313, an identifier determination unit 314, a virtual device storage unit 315, and a virtual identifier management unit 316.

The functions of the above-described respective processing units included in the management server 102 are realized by the CPU 223 executing a program stored in the ROM 224 or the HDD 226. Further, the CPU 223 executes the relevant program using various information stored in the RAM 225 or the HDD 226.

The sending/receiving unit 309 performs all of the sending and receiving processing of information between the management server 102 and the image forming apparatus 103, and all of the sending and receiving processing of information between the management server 102 and the client PC 105.

The virtual device setting unit 310 receives a virtual device generation request sent from a virtual device information input unit 318 in the client PC 105. The virtual device generation request includes management information about the image forming apparatus 103 and a virtual identifier issued by the virtual identifier issuing unit 312.

The virtual device setting unit 310 functions as a generation unit which, based on the received virtual device generation request, generates (sets) correspondence information between the management information about the image forming apparatus 103 included in the virtual device generation request and the virtual identifier as a virtual device. The virtual device setting unit 310 stores the generated virtual device in the virtual device storage unit 315.

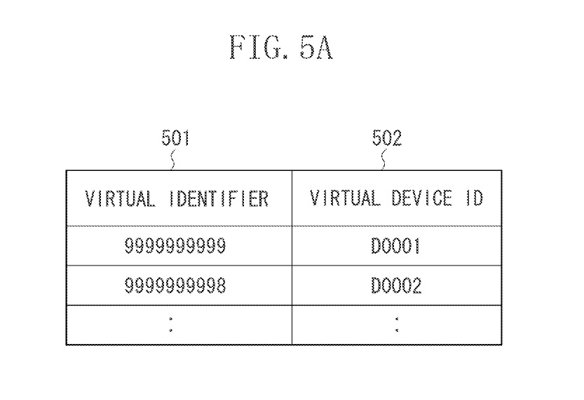

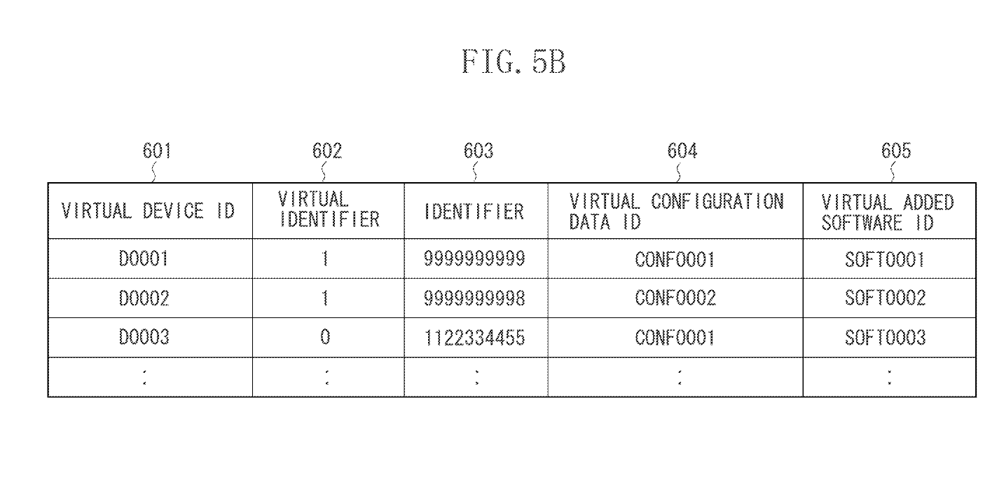

Specifically, the virtual device setting unit 310 sets a virtual device by setting information from the virtual device ID 601 to the virtual added software ID 605 illustrated in FIG. 5B. The virtual device storage unit 315 stores the virtual device set by the virtual device setting unit 310 (i.e., second storage unit).

Further, the virtual device storage unit 315 stores virtual configuration data associated with the virtual device. In addition, the virtual device storage unit 315 stores virtual added software data associated with the virtual device. The virtual added software data is management information about the virtual added software.

The virtual device sending unit 311 acquires from the virtual device storage unit 315 the virtual device corresponding to the virtual device acquisition request from the virtual device acquisition request unit 302 in the image forming apparatus 103 based on an instruction from the identifier determination unit 314. Further, the virtual device sending unit 311 sends the acquired virtual device to the virtual device acquisition request unit 302 in the image forming apparatus 103 via the sending/receiving unit 309 and the network 101 as a response to the virtual device acquisition request.

The virtual identifier issuing unit 312 functions as an issuing unit that receives a virtual identifier issuance request from the virtual device information input unit 318 in the client PC 105, and issues a virtual identifier based on the received issuance request.

The virtual identifier management unit 316 stores and manages the virtual identifier issued by the virtual identifier issuing unit 312 (i.e., a first storage unit). Specifically, the virtual identifier management unit 316 manages the virtual identifier as a part of the virtual identifier data illustrated in FIG. 5A.

The virtual identifier sending unit 313 receives the virtual identifier acquisition request from the virtual identifier display/printing unit 319 in the client PC 105. The virtual identifier acquisition request is a request for a virtual identifier to be sent. The virtual identifier acquisition request includes a virtual device ID, (i.e., identification information about the virtual device).

This virtual device ID corresponds to the image forming apparatus 103 the management information of which is managed by the management server 102. Further, the virtual identifier sending unit 313 acquires the virtual identifier corresponding to this virtual device acquisition request from the virtual identifier management unit 316, and sends the acquired virtual identifier to the virtual identifier display/printing unit 319 in the client PC 105.

The identifier determination unit 314 functions as a request receiving unit that receives the virtual device acquisition request from the virtual device acquisition request unit 302 in the image forming apparatus 103 via the network 101.

The identifier determination unit 314 determines the virtual device corresponding to the identifier included in the virtual device acquisition request as the virtual device corresponding to that virtual device acquisition request. Further, the identifier determination unit 314 instructs the virtual device sending unit 311 to send the determined virtual device from the virtual device storage unit 315 to the image forming apparatus 103.

The specific processing performed by the identifier determination unit 314 will now be described. First, the identifier determination unit 314 functions as a determination unit that determines whether the virtual identifier included in the virtual device acquisition request is stored in the virtual identifier management unit 316.

If the virtual identifier included in the virtual device acquisition request is stored in the virtual identifier management unit 316, the identifier determination unit 314 specifies the virtual device corresponding to the virtual identifier included in the virtual device acquisition request from among the virtual devices stored in the virtual device storage unit 315. Further, the identifier determination unit 314 functions as an update unit that updates the specified virtual device by replacing the virtual identifier included in the specified virtual device with the actual identification information included in the virtual device acquisition request.

The identifier determination unit 314 determines the updated virtual device to be the virtual device corresponding to the virtual device acquisition request. Therefore, the virtual device sending unit 311 functions as a sending unit that sends the updated virtual device to the image forming apparatus 103 via the network 101.

Further, the identifier determination unit 314 functions as a deletion unit that, after replacement has been performed, deletes the replaced virtual identifier, i.e., the virtual identifier included in the virtual device acquisition request, from the virtual identifier management unit 316.

The client PC 105 includes the sending/receiving unit 317, the virtual device information input unit 318, and the virtual identifier display/printing unit 319. The sending/receiving unit 317 performs all of the sending and receiving processing of information between the client PC 105 and the management server 102.

The virtual device information input unit 318 generates a virtual device generation request and a virtual identifier issuance request based on a user operation. Further, the virtual device information input unit 318 sends the virtual device generation request and the virtual identifier issuance request to the management server 102 via the sending/receiving unit 317 and the network 101.

The virtual identifier display/printing unit 319 sends a virtual identifier acquisition request to the virtual identifier sending unit 313 in the management server 102. The virtual identifier display/printing unit 319 acquires the virtual identifier from the virtual identifier sending unit 313 based on the virtual identifier acquisition request, and outputs (displays or prints) that virtual identifier.

The user confirms the output virtual identifier and performs an operation to input this virtual identifier into the image forming apparatus 103. The virtual identifier input unit 303 in the image forming apparatus 103 inputs that virtual identifier based on this user operation.

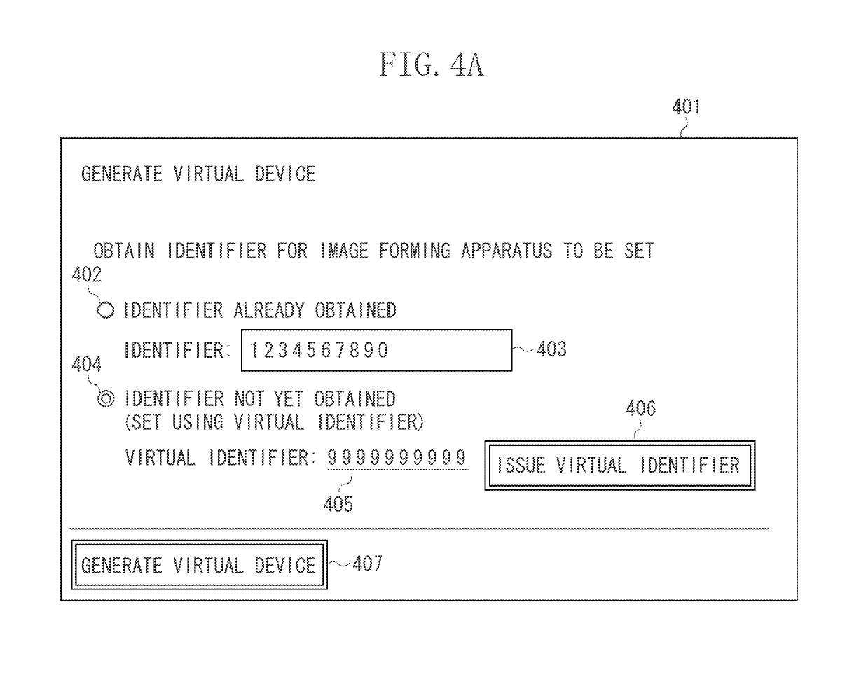

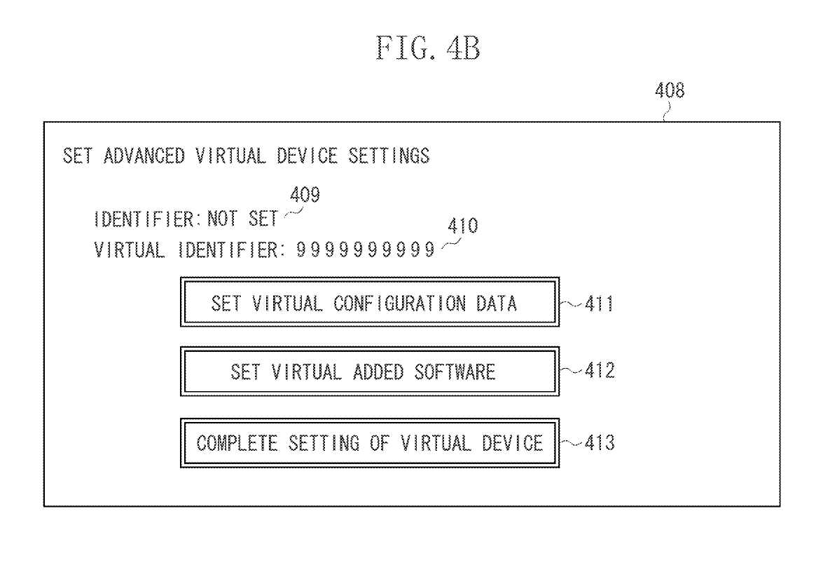

FIGS. 4A and 4B respectively illustrate an example of a virtual device generation screen and a virtual device advanced settings screen. FIG. 4A illustrates an example of a virtual device generation screen 401. The virtual device generation screen is a user interface (UI) for generating a virtual device generation request. The virtual device information input unit 318 in the client PC 105 displays the virtual device generation screen 401 based on a user operation.

A radio button 402 is a button that is selected by the user when the user has obtained the actual identifier for the image forming apparatus. The actual identifier is an identifier for the image forming apparatus that has been determined as being installed at the user's environment.

For example, if an image forming apparatus purchased by the user has arrived from the vendor, the identifier that this image forming apparatus has is the actual identifier. Therefore, the user has obtained the actual identifier. In this case, the user selects the radio button 402, and inputs the actual identifier in a text control 403.

A radio button 404 is a button that is selected by the user when the user has not obtained the actual identifier for an image forming apparatus. For example, if an image forming apparatus purchased by the user has not yet arrived from the vendor, the user selects the radio button 404. Then, the user clicks on a button 406.

When the button 406 is clicked on, the virtual device information input unit 318 generates a virtual identifier issuance request, and sends the generated issuance request to the management server 102. The virtual identifier issuing unit 312 in the management server 102 issues a virtual identifier based on the virtual identifier issuance request. When the virtual device information input unit 318 receives the issued virtual identifier from the management server 102, the virtual device information input unit 318 displays the virtual identifier in a text area 405.

Next, when the user clicks on a button 407, the virtual device information input unit 318 generates a virtual device generation request, and sends the generated generation request to the management server 102. If the radio button 402 is selected, the virtual device information input unit 318 generates a virtual device generation request that includes the identifier input in the text control 403.

Consequently, the virtual device setting unit 310 in the management server 102 that has received the virtual device generation request generates a virtual device for which the identifier including the virtual device generation request serves as a key.

Further, if the radio button 404 is selected, the virtual device information input unit 318 generates a virtual device generation request that includes the virtual identifier displayed in the text area 405. Consequently, the virtual device setting unit 310 in the management server 102 that has received the virtual device generation request generates a virtual device for which the virtual identifier including the virtual device generation request serves as a key.

When a virtual device is generated, the virtual device information input unit 318 transitions the display screen to the virtual device advanced settings screen.

FIG. 4B illustrates an example of a virtual device advanced settings screen. The virtual device advanced settings screen 408 is a UI for setting the advanced settings for a virtual device generated by the virtual device setting unit 310 in the management server 102.

An identifier that will serve as a key for the generated virtual device is set in a text area 409. A virtual identifier that will serve as a key for the generated virtual device is set in a text area 410. In this example, the virtual identifier “9999999999” is set in the text area 410.

A button 411 is for calling up a (not illustrated) virtual configuration data setting screen. The virtual configuration data setting screen is a UI for setting virtual configuration data to be set for a generated virtual device. A button 412 is for calling up a (not illustrated) virtual added software setting screen.

When the user sets the virtual configuration data on the virtual configuration data setting screen, virtual configuration data setting information is input. The virtual configuration data setting information includes at least a virtual configuration data ID for the virtual configuration data.

The virtual added software setting screen is a UI for setting virtual added software to be set for a generated virtual device. When the user sets the virtual added software on the virtual added software setting screen, virtual added software setting information is input.

The virtual added software setting information includes at least a virtual added software ID. The virtual added software ID is identification information that uniquely identifies virtual added software.

The virtual device information input unit 318 sends the input virtual configuration data setting information and the virtual added software setting information to the virtual device setting unit 310 in the management server 102. The virtual device setting unit 310 receives the virtual configuration data setting information and the virtual added software setting information, and sets this information for the virtual device.

FIGS. 5A and 5B respectively illustrate an example of virtual identifier data and a virtual device. FIG. 5A illustrates an example of virtual identifier data. The virtual identifier data includes data items such as a virtual identifier 501 and a virtual device ID 502. The virtual identifier 501 is issued by the virtual identifier issuing unit 312. The virtual device ID is identification information that uniquely identifies virtual added software.

FIG. 5B illustrates an example of a virtual device. The virtual device includes data items such as a virtual device ID 601, a virtual identifier 602, an identifier 603, a virtual configuration data ID 604, and a virtual added software ID 605.

The virtual device ID 601 is the same as the virtual device ID 501 illustrated in FIG. 5A. The virtual identifier 602 indicates that the value set in the identifier 603 is either a virtual identifier or an actual identifier. In this example, a value of “1” set in the virtual identifier 602 indicates that the value set in the identifier 603 is a virtual identifier.

A value of “0” set in the virtual identifier 602 indicates that the value set in the identifier 603 is an actual identifier. If the value set in the identifier 603 is a virtual identifier, this means that the same virtual identifier as the virtual identifier set for the identifier 603 is present in the virtual identifier data illustrated in FIG. 5A.

The identifier 603 is a virtual identifier or an actual identifier. The virtual configuration data ID 604 is identification information that identifies the virtual configuration data corresponding to the image forming apparatus having the identifier set in the identifier 603. The virtual added software ID 605 is identification information that identifies the virtual added software corresponding to the image forming apparatus having the identifier set in the identifier 603.

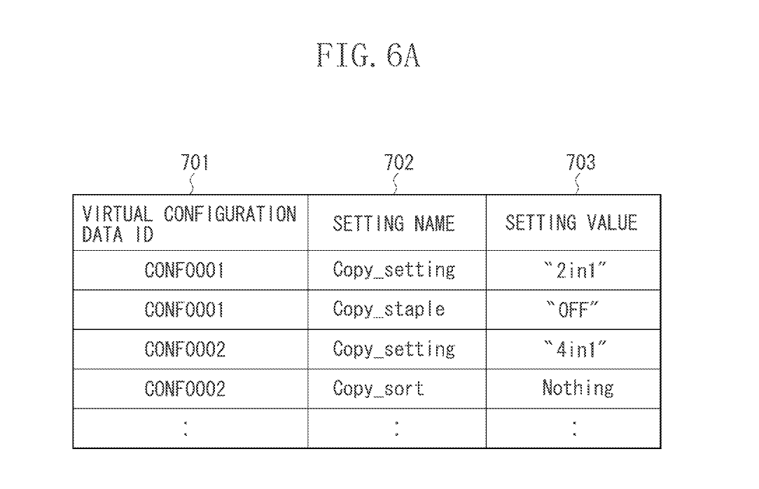

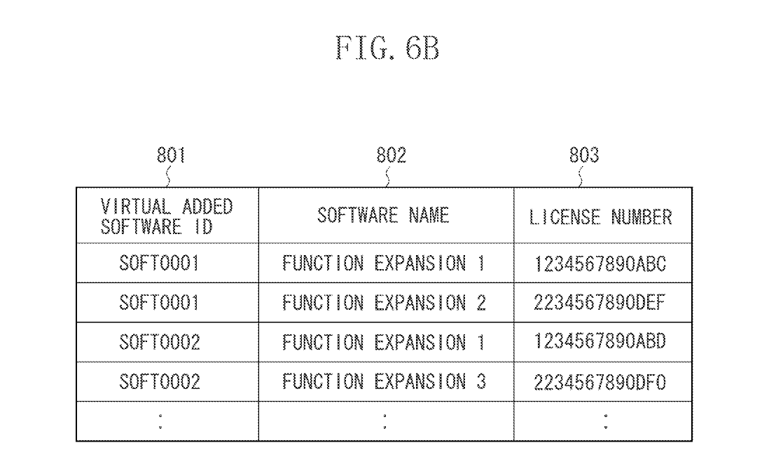

FIGS. 6A and 6B respectively illustrate an example of virtual configuration data and virtual added software data. FIG. 6A illustrates an example of virtual configuration data. The virtual configuration data includes data items such as a virtual configuration data ID 701, a setting name 702, and a setting value 703. The virtual configuration data ID 701 is the same as the virtual configuration data ID 604 in FIGS. 6A and 6B. The setting name 702 is a setting name corresponding to the virtual configuration data ID 701.

The virtual configuration data ID 701 and the setting name 702 serve as keys for specifying a virtual configuration data record. In this example, a copy imposition setting called “Copy_setting” is set for the setting name 702. The setting value 703 is the actual setting value of the setting name 702. In this example, “2 in 1” is set as the setting value for the setting value “Copy_setting” for the virtual configuration data “CONF0001”.

FIG. 6B illustrates an example of virtual added software data. The virtual added software data includes data items such as a virtual added software ID 801, a software name 802, and a license number 803. The virtual added software ID 801 is the same as the virtual added software ID 605 in FIG. 5B.

The software name 802 is the software name of the added software corresponding to the virtual added software ID 801. The virtual added software ID 801 and the software name 802 serve as keys for specifying a virtual added software data record.

The license number 803 is license information corresponding to the virtual added software specified by the virtual added software ID 801 and the software name 802. The license information is used when installing the virtual added software.

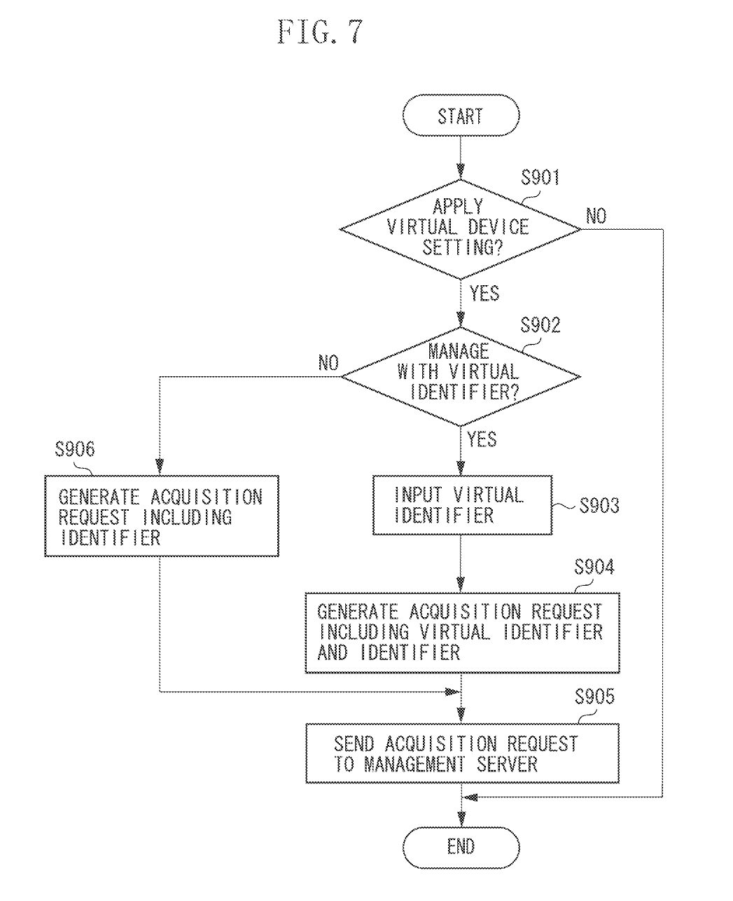

FIG. 7 is a flowchart illustrating an example of virtual device acquisition processing performed by the image forming apparatus. First, in step S901, the virtual device acquisition request unit 302 in the image forming apparatus 103 determines whether the user has performed an operation for applying a setting of a virtual device managed by the management server 102 to the image forming apparatus.

An example of an operation for applying a virtual device setting to the image forming apparatus is an operation for applying virtual configuration data to the image forming apparatus. The operation for applying a virtual device setting to the image forming apparatus can also be an operation for installing virtual added software in the image forming apparatus.

If it is determined that the user has not performed an operation for applying a setting of a virtual device managed by the management server 102 to the image forming apparatus (NO in step S901), the processing is ended. If it is determined that the user has performed an operation for applying a setting of a virtual device managed by the management server 102 to the image forming apparatus (YES in step S901), the processing proceeds to step S902.

Next, in step S902, the virtual device acquisition request unit 302 selects whether the virtual device to which the setting is to be applied will be managed with a virtual identifier by the management server 102. For example, the user instructs the virtual identifier display/printing unit 319 in the client PC 105 to acquire and output the virtual identifier corresponding to the image forming apparatus 103 from the management server 102.

If the virtual identifier display/printing unit 319 in the client PC 105 has output the virtual identifier corresponding to the image forming apparatus 103, the user recognizes that the virtual device is managed based on an association with a virtual identifier. Therefore, the user selects that the virtual device is being managed with a virtual identifier.

If the virtual identifier display/printing unit 319 in the client PC 105 has not output the virtual identifier corresponding to the image forming apparatus 103, the user recognizes that the virtual device is not managed with a virtual identifier. Therefore, the user selects that the virtual device is not being managed with a virtual identifier.

When the virtual identifier display/printing unit 319 receives the issued virtual identifier from the management server 102, for example, this virtual identifier may also be stored in a storage unit. Further, the user may also instruct the virtual identifier display/printing unit 319 to display the virtual identifier corresponding to the image forming apparatus 103 from among these stored virtual identifiers. Based on the display result, the user may recognize whether the virtual device is being managed with a virtual identifier.

If it is determined that the virtual device acquisition request unit 302 has selected that the virtual device to which the setting is to be applied is not being managed with a virtual identifier by the management server 102 (NO in step S902), the processing proceeds to step S906. Next, in step S906, the virtual device acquisition request unit 302 acquires the actual identifier stored in the identifier storage unit 301 in the image forming apparatus 103. Then, the virtual device acquisition request unit 302 generates a virtual device acquisition request that includes the acquired actual identifier, and then the processing proceeds to step S905.

If it is determined that the virtual device acquisition request unit 302 has selected that the virtual device to which the setting is to be applied is being managed with a virtual identifier by the management server 102 (YES in step S902), the processing proceeds to step S903. In step S903, the virtual identifier input unit 303 inputs the virtual identifier based on a user operation. The processing in step S303 may also be performed so that the virtual identifier display/printing unit 319 scans the printed and output virtual identifier, and inputs the scanned virtual identifier.

Next, the virtual device acquisition request unit 302 acquires the actual identifier stored in the identifier storage unit 301 in the image forming apparatus 103. Then, in step S904, the virtual device acquisition request unit 302 generates a virtual device acquisition request that includes the acquired actual identifier and the input virtual identifier, and the processing proceeds to step S905.

In step S905, the virtual device acquisition request unit 302 sends the generated virtual device acquisition request to the management server 102 via the sending/receiving unit 308, and ends the processing.

Based on the processing illustrated in FIG. 7, the image forming apparatus 103 can make a virtual device acquisition request that includes a virtual identifier when utilizing a virtual identifier and that does not include a virtual identifier when not utilizing a virtual identifier.

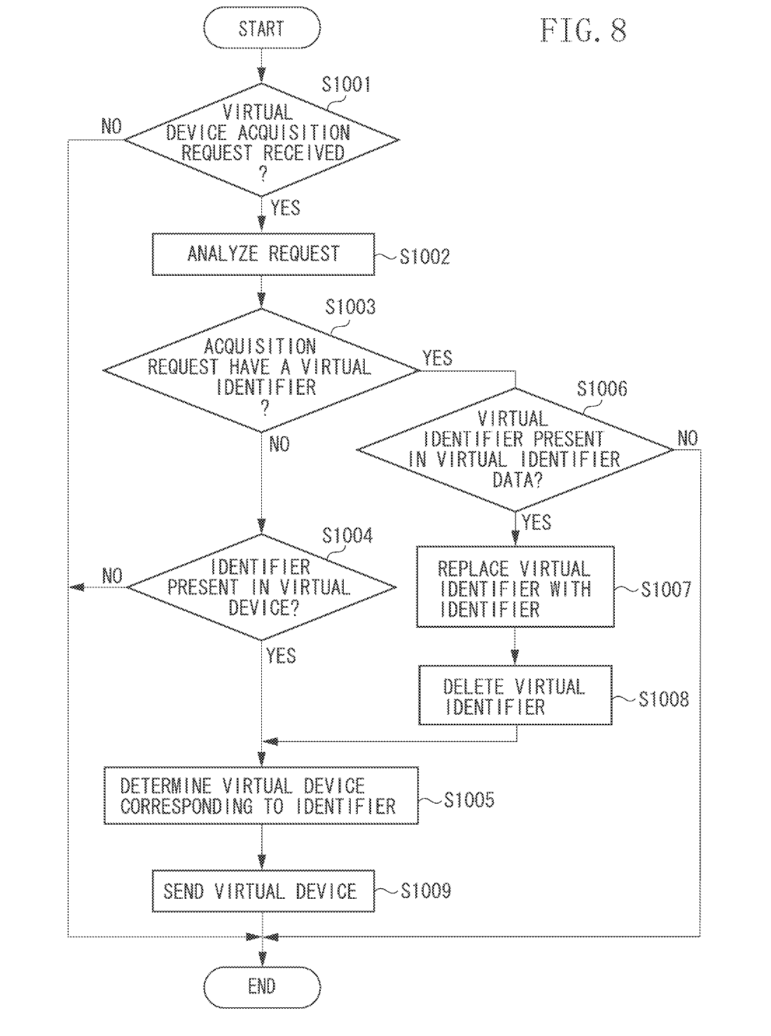

FIG. 8 is a flowchart illustrating an example of management server operation processing. First, in step S1001, the identifier determination unit 314 in the management server 102 determines whether a virtual device acquisition request has been received from the image forming apparatus 103. If the identifier determination unit 314 determines that a virtual device acquisition request has not been received from the image forming apparatus 103 (NO in step S1001), the processing is ended. However, if the identifier determination unit 314 determines that a virtual device acquisition request has been received from the image forming apparatus 103 (YES in step S1001), the processing proceeds to step S1002.

Next, in step S1002, the identifier determination unit 314 analyzes the virtual device acquisition request. Specifically, the identifier determination unit 314 analyzes the contents of the identifier included in the virtual device acquisition request.

Next, in step S1003, the identifier determination unit 314 determines whether the virtual device acquisition request includes a virtual identifier. If it is determined that the virtual device acquisition request includes a virtual identifier (YES in step S1003), the processing proceeds to step S1006. If it is determined that the virtual device acquisition request does not include a virtual identifier (NO in step S1003), the processing proceeds to step S1004.

In step S1004, the identifier determination unit 314 determines whether the identifier included in the virtual device acquisition request is present in the virtual device (FIG. 5B). If it is determined that the identifier included in the virtual device acquisition request is not present in the virtual device (NO in step S1004), the processing is ended. If it is determined that the identifier included in the virtual device acquisition request is present in the virtual device (YES in step S1004), the processing proceeds to step S1005.

Next, in step S1005, the identifier determination unit 314 determines the virtual device corresponding to the identifier. Then, the identifier determination unit 314 instructs the virtual device sending unit 311 to acquire the determined virtual device from the virtual device storage unit 315. In step S1009, the virtual device sending unit 311 acquires the determined virtual device from the virtual device storage unit 315, and sends the acquired virtual device to the virtual device acquisition request unit 302 in the image forming apparatus 103.

In step S1006, the identifier determination unit 314 determines whether the virtual identifier included in the virtual device acquisition request is present in the virtual identifier data (FIG. 5A). If it is determined that the virtual identifier included in the virtual device acquisition request is not present in the virtual identifier data (NO in step S1006), the processing finishes.

If it is determined that the virtual identifier included in the virtual device acquisition request is present in the virtual identifier data (YES in step S1006), the processing proceeds to step S1007. Then, the identifier determination unit 314 specifies the virtual device corresponding to the virtual identifier included in the virtual device acquisition request from among the virtual devices stored in the virtual device storage unit 315. In step S1007, the identifier determination unit 314 replaces the virtual identifier included in the specified virtual device with the actual identifier included in the virtual device acquisition request.

Next, in step S1008, the identifier determination unit 314 deletes the virtual identifier that was replaced with the actual identifier in step S1007 from the virtual identifier data, and the processing proceeds to step S1005.

With the management system according to the present exemplary embodiment, management information about an image forming apparatus can be managed by a management server using a virtual identifier even when the image forming apparatus machine to be applied at a user's environment is yet to be determined. Consequently, for example, the management server can set in advance in the image forming apparatus configuration data and added software to be applied at the user's environment.

Further, with the management system according to the present exemplary embodiment, an image forming apparatus can acquire a desired virtual device corresponding to the actual identifier of the image forming apparatus by making a virtual device acquisition request to the management server at a stage when the image forming apparatus has been determined.

Further, although the image forming apparatus 103 applies virtual configuration data and virtual added software corresponding to the virtual device acquired from the management server 102, an arbitrary method may be employed as this application method.

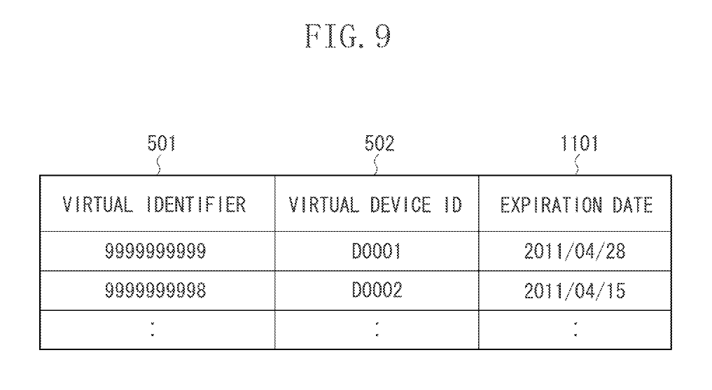

Another exemplary embodiment of the present invention will now be described. FIG. 9 illustrates an example of virtual identifier data according to another exemplary embodiment. This virtual identifier data includes, in addition to a virtual identifier 501 and a virtual device ID, an expiration date 1101. The expiration date is an expiration date for the virtual identifier. That is, the virtual identifier management unit 316 associates a virtual identifier with an expiration date for that virtual identifier, and stores the resultant information.

In the present exemplary embodiment, in the determination processing performed in step S1006 of FIG. 8, the identifier determination unit 314 determines whether a virtual identifier that is included in a virtual device acquisition request, and whose expiration date has not expired (not yet passed), is stored in the virtual identifier data.

If the identifier determination unit 314 determines that a virtual identifier that is included in a virtual device acquisition request and whose expiration date has not expired is present in the virtual identifier data (YES in step S1006), the processing proceeds to step S1007. In this case, the identifier determination unit 314 updates the virtual device and deletes the virtual identifier.

If the identifier determination unit 314 determines that a virtual identifier that is included in a virtual device acquisition request is not stored in the virtual identifier data, or determines that although a virtual identifier is stored, its expiration date is expired (NO in step S1006), the processing is ended. In this case, the identifier determination unit 314 does not update the virtual device or delete the virtual identifier.

Further, in this case, the identifier determination unit 314 does not instruct the virtual device sending unit 311 to acquire the virtual device corresponding to the virtual device acquisition request. Therefore, the virtual device sending unit 311 does not respond to the virtual device acquisition request.

Even if an expiration date is not set for the virtual identifier, unless there is a virtual device acquisition request from the target image forming apparatus, the virtual identifier will always be in a valid state. In this case, the virtual device may be applied to a different image forming apparatus due to an input mistake by another user.

The management server according to the present exemplary embodiment is configured so as not to send a virtual device to an image forming apparatus when a virtual device acquisition request including a virtual identifier whose expiration date has expired is received. Consequently, the application of this virtual device to an image forming apparatus different from the image forming apparatus to which the virtual device is to be applied can be prevented.

Aspects of the present invention can also be realized by a computer of a system or apparatus (or devices such as a CPU or a micro-processing unit (MPU) which may also be referred to as a microprocessor) that reads out and executes software (a program) recorded on a memory device (computer-readable medium) to perform the functions of one or more of the above-described embodiments. In such a case, this program, and the storage medium where the program is stored, are included as being within the scope of the present invention. The program can be provided to the computer for example via a network or from a recording medium of various types serving as the memory device (e.g., non-transitory computer-readable medium). The computer-readable medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-181473 filed Aug. 23, 2011, which is hereby incorporated by reference herein in its entirety.

What is claimed is:

1. A management system comprising an image forming apparatus and a server apparatus configured to manage management information about the image forming apparatus that includes at least operation setting information for switching an operation in the image forming apparatus,
wherein the server apparatus comprises:
an issuing unit configured to issue provisional identification information about the image forming apparatus;
a first storage unit configured to store the issued provisional identification information;
a generation unit configured to generate correspondence information as apparatus information between the management information about the image forming apparatus and the provisional identification information;
a second storage unit configured to store the generated apparatus information;
a request receiving unit configured to receive an acquisition request for the apparatus information that includes the provisional identification information about the image forming apparatus and actual identification information about the image forming apparatus from the image forming apparatus via a network;
an update unit configured to specify apparatus information corresponding to the provisional identification information included in the apparatus information acquisition request from among apparatus information stored in the second storage unit, and update the specified apparatus information by associating the specified apparatus information with the actual identification information included in the apparatus information acquisition request; and
a sending unit configured to send the updated apparatus information to the image forming apparatus via the network.

2. The management system according to claim 1,
wherein the first storage unit is configured to store the provisional identification information by associating the provisional identification information with an expiration date, and
wherein the update unit is configured to, when the request receiving unit has received an acquisition request for the apparatus information, determine whether provisional identification information that is included in an acquisition request for the apparatus information and whose expiration date has not expired is stored in the first storage unit, and when provisional identification information that is included in an acquisition request for the apparatus information and whose expiration date has not expired is stored in the first storage unit, the update unit is configured not to update apparatus information corresponding to the provisional identification information that is included in an acquisition request for the apparatus information, and the sending unit is configured to not respond to the apparatus information acquisition request.

3. The management system according to claim 1, wherein the issuing unit is configured to receive an issuance request for the provisional identification information from the image forming apparatus, and issue the provisional identification information based on the received issuance request for provisional identification information, and
wherein the generation unit is configured to receive a generation request for the apparatus information from the image forming apparatus, and generate the apparatus information based on the received generation request for apparatus information.

4. The management system according to claim 1, wherein the management information includes information relating to software to be applied by the image forming apparatus.

5. A method for managing, in a server apparatus, management information about an image forming apparatus that includes operation setting information for switching an operation in the image forming apparatus, the method comprising:
issuing by the server apparatus provisional identification information about the image forming apparatus by the server apparatus;
storing by the server apparatus the issued provisional identification information by the server apparatus;
generating by the server apparatus correspondence information between the management information about the image forming apparatus and the provisional identification information as apparatus information;
storing by the server apparatus the generated apparatus information;
receiving by the server apparatus an acquisition request for the apparatus information that includes the provisional identification information about the image forming apparatus and actual identification information about the image forming apparatus from the image forming apparatus via a network;
specifying by the server apparatus information corresponding to the provisional identification information included in the apparatus information acquisition request from among apparatus information stored in the second storage unit, and updating by the server apparatus the specified apparatus information by associating the specified apparatus information with the actual identification information included in the apparatus information acquisition request; and
sending by the server apparatus the updated apparatus information to the image forming apparatus via the network.

6. A non-transitory computer-readable storage medium that stores a computer program configured to execute the management method according to claim 5.
